(19) United States
(12) Patent Application Publication
(10) Pub. No.: US 2026/0214326 A1
(43) Pub. Date: Jul. 23, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Tomoyuki IWAO, Saitama (JP); Kazuya OKIYAMA, Saitama (JP); Daisuke HAYASHI, Saitama (JP); Isao KOIZUMI, Saitama (JP)

(73) Assignee: FUJIFILM Corporation, Tokyo (JP)

(21) Appl. No.: 19/571,432

(22) Filed: Mar. 18, 2026

Related U.S. Application Data
(63) Continuation of application No. PCT/JP2024/031983, filed on Sep. 6, 2024.

(30) Foreign Application Priority Data
Sep. 22, 2023 (JP) 2023-158620

(51) Int. Cl. H04N 23/661; G06T 1/60

(52) U.S. Cl. CPC H04N 23/661; G06T 1/60

(57) ABSTRACT

An information processing apparatus includes a processor, in which the processor is configured to perform processing of connecting to and communicating with an imaging apparatus, acquire first file format information indicating an image file format supported by the imaging apparatus, and based on the first file format information, generate second file format information indicating an image file format that is supported by the imaging apparatus and is supported by an information terminal, and perform a control based on the second file format information.

### CROSS REFERENCE TO RELATED APPLICATION

This is a continuation of International Application No. PCT/JP2024/031983 filed on Sep. 6, 2024, and claims priority from Japanese Patent Application No. 2023-158620 filed on, Sep. 22, 2023, the entire disclosures of which are incorporated herein by reference.

### BACKGROUND OF THE INVENTION

### 1. Field of the Invention

The present invention relates to an information processing apparatus, an information processing method, and a computer-readable storage medium storing an information processing program.

### 2. Description of the Related Art

JP2018-85692A discloses an image transmission apparatus that transmits image data to an external apparatus in response to a request for the image data that is received from the external apparatus and conforms to a first protocol, transmits information related to streaming to the external apparatus in response to a request for the information related to streaming of the image data that is received from the external apparatus and conforms to the first protocol, and streams the image data to the external apparatus in response to a streaming request that is received from the external apparatus, conforms to a second protocol, and is based on the transmitted information related to streaming.

JP2018-36703A discloses an information processing apparatus in which a control unit of a digital camera acquires identification information from a smartphone, in a case where transmission of image data stored in the control unit is requested from the smartphone, determines whether or not the identification information acquired from the smartphone is registered in the control unit, in a case where the identification information is registered, transmits the image data conforming to a first image format to the smartphone, and in a case where the identification information is not registered, transmits the image data conforming to a second image format different from the first image format to the smartphone.

JP2012-185853A discloses an information processing apparatus that acquires file format information of an image file stored in a communication device, and in a case where a request to display image data is received from a user, selects whether to request all regions of the file or to request a specific region of the file in accordance with the acquired file format.

### SUMMARY OF THE INVENTION

An embodiment according to the disclosed technology provides an information processing apparatus, an information processing method, and a storage medium storing an information processing program capable of performing a control based on information in a file format supported by both an imaging apparatus and an information processing apparatus.

(1)

An information processing apparatus comprises a processor, in which the processor is configured to perform processing of connecting to and communicating with an imaging apparatus, acquire first file format information indicating an image file format supported by the imaging apparatus, and based on the first file format information, generate second file format information indicating an image file format that is supported by the imaging apparatus and is supported by the information processing apparatus, and perform a control based on the second file format information.

(2)

In the information processing apparatus according to (1), the control based on the second file format information is a control related to reception of image data stored in the imaging apparatus.

(3)

In the information processing apparatus according to (2), the control based on the second file format information includes a control of receiving, from the imaging apparatus, information on image data that is stored in the imaging apparatus and corresponds to an image file format which is determined to be supported by the information processing apparatus based on the second file format information, and outputting the information to a display location.

(4)

In the information processing apparatus according to any one of (1) to (3), the control based on the second file format information includes user notification based on a file format set in the imaging apparatus and on the second file format information.

(5)

In the information processing apparatus according to (4), the user notification includes notification via the imaging apparatus or the information processing apparatus.

(6)

In the information processing apparatus according to any one of (1) to (5), the control based on the second file format information includes setting a file format in the imaging apparatus based on the second file format information.

(7)

In the information processing apparatus according to any one of (2) to (6), the control based on the second file format information includes a control of restricting reception, from the imaging apparatus, of image data that is stored in the imaging apparatus and corresponds to an image file format which is determined not to be supported by the information processing apparatus based on the second file format information.

(8)

In the information processing apparatus according to any one of (1) to (7), the processor is configured to acquire, from a data storage apparatus, third file format information indicating the image file format that is reproducible in the information processing apparatus, and generate the second file format information based on the first file format information and on the third file format information.

(9)

In the information processing apparatus according to any one of (1) to (8), the processor is configured to acquire test image data in an image file format supported by the imaging apparatus from a data storage apparatus or the imaging apparatus, and generate the second file format information based on the test image data.

(10)

In the information processing apparatus according to (9), the processor is configured to generate the second file format information based on a result of performing at least any of reproduction or storage of the test image data.

(11)

In the information processing apparatus according to any one of (8) to (10), the data storage apparatus is an apparatus different from the information processing apparatus.

(12)

In the information processing apparatus according to any one of (1) to (11), the processor is configured to acquire association information in which apparatus information is associated with the second file format information, and in a case where the apparatus information included in the association information coincides with apparatus information of the imaging apparatus and apparatus information of the information processing apparatus, perform the control based on the second file format information included in the association information.

(13)

In the information processing apparatus according to (12), the processor is configured to, in a case where the second file format information is generated, store association information in which the apparatus information of the imaging apparatus and the apparatus information of the information processing apparatus are associated with the second file format information, in a memory of the information processing apparatus, and acquire the association information from the memory.

(14)

In the information processing apparatus according to (12), the processor is configured to acquire the association information from an apparatus different from the information processing apparatus.

(15)

In the information processing apparatus according to any one of (1) to (14), the image file format includes at least any of an image size, a frame rate, or a compression codec.

(16)

In the information processing apparatus according to any one of (1) to (15), the image file format is a combination of a plurality of types of file formats.

(17)

An information processing apparatus that is a first information processing apparatus includes a processor, in which the processor is configured to perform processing of connecting to and communicating with an imaging apparatus, and acquire first file format information indicating an image file format supported by the imaging apparatus, and based on the first file format information, generate second file format information indicating an image file format that is supported by the imaging apparatus and is supported by a second information processing apparatus.

(18)

An information processing method performed by an information processing apparatus including a processor comprises, via the processor, performing processing of connecting to and communicating with an imaging apparatus, acquiring first file format information indicating an image file format supported by the imaging apparatus, and based on the first file format information, generating second file format information indicating an image file format that is supported by the imaging apparatus and is supported by the information processing apparatus, and performing a control based on the second file format information.

(19)

An information processing program of an information processing apparatus including a processor causes the processor to execute a process comprising performing processing of connecting to and communicating with an imaging apparatus, acquiring first file format information indicating an image file format supported by the imaging apparatus, and based on the first file format information, generating second file format information indicating an image file format that is supported by the imaging apparatus and is supported by the information processing apparatus, and performing a control based on the second file format information.

According to the present invention, an information processing apparatus, an information processing method, and an information processing program capable of performing a control based on information in a file format supported by both an imaging apparatus and an information processing apparatus can be provided.

### BRIEF DESCRIPTION OF THE DRAWINGS

FIG. 1 is a diagram showing an example of a communication system to which an information processing apparatus of an embodiment is applied.

FIG. 2 is a diagram showing an example of a hardware configuration of an imaging apparatus 10.

FIG. 3 is a diagram showing an example of a hardware configuration of an information terminal 20.

FIG. 4 is a flowchart showing an example of processing performed by a processor 21 of the information terminal 20.

FIG. 5 is a flowchart showing a first modification example of the processing performed by the processor 21 of the information terminal 20.

FIG. 6 is a flowchart showing a second modification example of the processing performed by the processor 21 of the information terminal 20.

FIG. 7 is a flowchart showing a third modification example of the processing performed by the processor 21 of the information terminal 20.

FIG. 8 is a flowchart of the third modification example following FIG. 7.

FIG. 9 is a flowchart showing a fourth modification example of the processing performed by the processor 21 of the information terminal 20.

FIG. 10 is a flowchart showing a fifth modification example of the processing performed by the processor 21 of the information terminal 20.

FIG. 11 is a diagram showing an example of a warning message displayed on the imaging apparatus 10.

FIG. 12 is a diagram showing an example of a warning message displayed on the information terminal 20.

FIG. 13 is a flowchart showing a sixth modification example of the processing performed by the processor 21 of the information terminal 20.

FIG. 14 is a flowchart showing a seventh modification example of the processing performed by the processor 21 of the information terminal 20.

### DESCRIPTION OF THE PREFERRED EMBODIMENTS

Hereinafter, an example of an embodiment of the present invention will be described with reference to the drawings.

### Communication System to which Information Processing Apparatus According to Embodiment of Present Invention is Applied

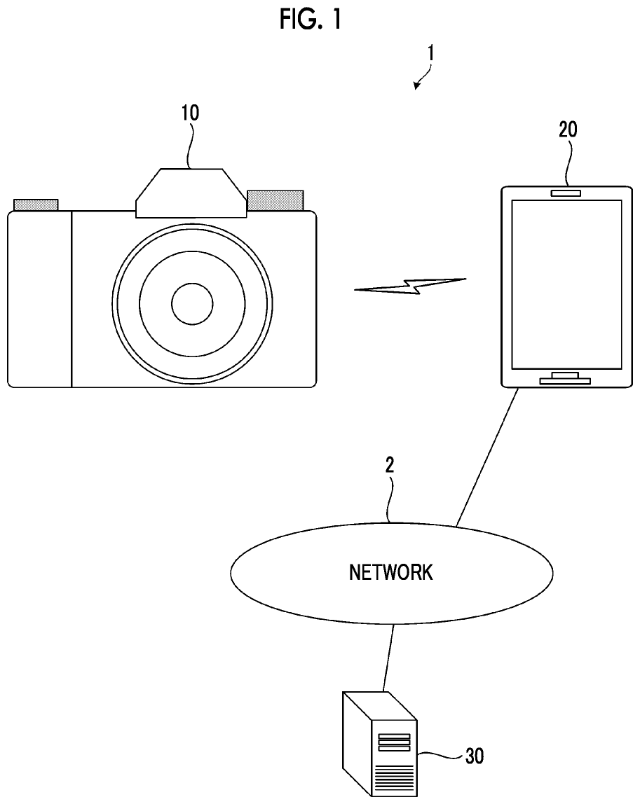

FIG. 1 is a diagram showing an example of a communication system to which an information processing apparatus of the embodiment is applied. A communication system 1 shown in FIG. 1 comprises an imaging apparatus 10, an information terminal 20, and a server 30.

The imaging apparatus 10 is, for example, a digital camera. The imaging apparatus 10 can capture a still image and a video. The imaging apparatus 10 can wirelessly communicate with the information terminal 20. The imaging apparatus 10 transmits, for example, information related to an imaging apparatus including image data captured by the imaging apparatus 10 to the information terminal 20 via wireless communication. The imaging apparatus 10 can wirelessly communicate with the information terminal 20 using, for example, Wi-Fi 5 (registered trademark) or Wi-Fi 6 (registered trademark). Communication between the imaging apparatus 10 and the information terminal 20 may be wired communication.

The information terminal 20 is an example of an “information processing apparatus” according to the embodiment of the present invention. The information terminal 20 is, for example, a smartphone or a tablet terminal. The information terminal 20 can wirelessly communicate with the imaging apparatus 10. The information terminal 20 transmits, for example, a control signal related to reception of the image data captured by the imaging apparatus 10 to the imaging apparatus 10 via wireless communication. The information terminal 20 can connect to the server 30 through a network 2. The information terminal 20 can connect to the network 2 via, for example, wired local area network (LAN) communication. The information terminal 20 may be connectable to the network 2 via, for example, wireless LAN communication or mobile communication. The network 2 is, for example, a wide area network (WAN) such as the Internet. The information terminal 20 transmits, for example, a control signal related to reception of the image data captured by the imaging apparatus 10 to the server 30 through the network 2.

The server 30 is an example of a “data storage apparatus” according to the embodiment of the present invention. The server 30 may be, for example, a cloud server. The server 30 stores, for example, information related to reception of the image data captured by the imaging apparatus 10. The server 30 can connect to the network 2. The server 30 transmits information related to reception of the image data captured by the imaging apparatus 10 to the information terminal 20, in response to a request from the information terminal 20 connected to the network 2.

### Hardware Configuration of Imaging Apparatus 10

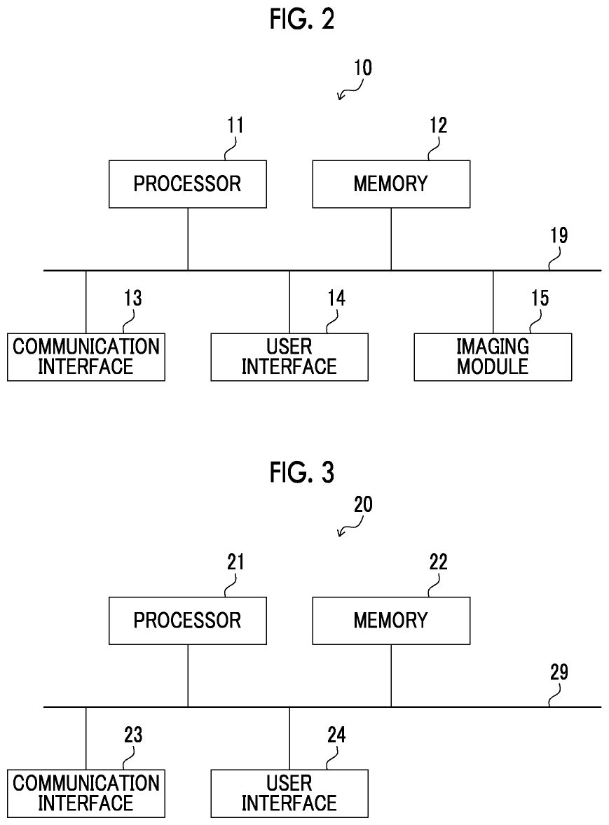

FIG. 2 is a diagram showing an example of a hardware configuration of the imaging apparatus 10. As shown in FIG. 2, the imaging apparatus 10 comprises a processor 11, a memory 12, a communication interface 13, a user interface 14, and an imaging module 15. The processor 11, the memory 12, the communication interface 13, the user interface 14, and the imaging module 15 are connected through, for example, a bus 19.

The processor 11 is a circuit that performs signal processing, and is, for example, a CPU that controls the whole imaging apparatus 10. The processor 11 may be implemented by other digital circuits such as an FPGA and a digital signal processor (DSP). The processor 11 may be implemented by a combination of a plurality of digital circuits.

The memory 12 includes, for example, a main memory and an auxiliary memory. The main memory is, for example, a random-access memory (RAM). The main memory is used as a work area of the processor 11. The auxiliary memory is, for example, a non-volatile memory such as a magnetic disk or a flash memory. The auxiliary memory stores various programs for operating the imaging apparatus 10. The programs stored in the auxiliary memory are loaded into the main memory and executed by the processor 11. The auxiliary memory may include a portable memory that can be detached from the imaging apparatus 10. Examples of the portable memory include a universal serial bus (USB) flash drive, a memory card such as a secure digital (SD) memory card, and an external hard disk drive.

The communication interface 13 is a communication interface that communicates with an apparatus (for example, the information terminal 20) outside the imaging apparatus 10. The communication interface 13 includes at least any of a wired communication interface for performing wired communication or a wireless communication interface for performing wireless communication. The communication interface 13 is controlled by the processor 11.

The user interface 14 includes, for example, an input device that receives an operation input from a user, and an output device that outputs information to the user. The input device can be implemented by, for example, a key operation unit or a remote controller. The output device can be implemented by, for example, a display or a speaker. In the imaging apparatus 10 shown in FIG. 1, the input device and the output device are implemented by a touch panel. The user interface 14 is controlled by the processor 11. The imaging apparatus 10 receives various types of designation from the user using the user interface 14.

The imaging module 15 includes, for example, an imaging element that images a subject through an imaging optical system. The imaging optical system includes at least an imaging lens such as a focus lens or a zoom lens. The imaging element is composed of a charge coupled device (CCD) image sensor, a complementary metal oxide semiconductor (CMOS) image sensor, or the like. The imaging module 15 includes a signal processing circuit that performs sampling processing, digital conversion processing, and the like on a captured image signal output from the imaging element. The imaging module 15 includes an image processing unit that performs digital signal processing on the captured image signal after being processed by the signal processing circuit to generate captured image data in, for example, a joint photographic experts group (JPEG) format. The imaging module 15 is controlled by the processor 11.

The processor 11 implements a predetermined function by executing a control program. In the present embodiment, for example, an image transmission application for an imaging apparatus for transmitting the image data from the imaging apparatus 10 is installed in advance in the memory 12 as the control program. The processor 11 implements the predetermined function by executing the image transmission application.

### Hardware Configuration of Information Terminal 20

FIG. 3 is a diagram showing an example of a hardware configuration of the information terminal 20. As shown in FIG. 3, the information terminal 20 comprises a processor 21, a memory 22, a communication interface 23, and a user interface 24. The processor 21, the memory 22, the communication interface 23, and the user interface 24 are connected through, for example, a bus 29. The processor 21, the memory 22, the communication interface 23, and the user interface 24 are the same as the processor 11, the memory 12, the communication interface 13, and the user interface 14 of the imaging apparatus 10, respectively, described in FIG. 2.

While not shown in FIG. 3, the information terminal 20 may comprise an imaging apparatus (camera) that includes an imaging optical system and an imaging element, and can perform imaging, and a sensor that includes a space recognition sensor or the like capable of three-dimensionally recognizing a space around the information terminal 20.

In addition, for example, an image transmission application for an information terminal for transmitting the image data from the imaging apparatus 10 to the information terminal 20 is installed in advance in the memory 22 of the information terminal 20 as the control program. The processor 21 implements a predetermined function by executing the image transmission application.

### processing of Information Terminal 20

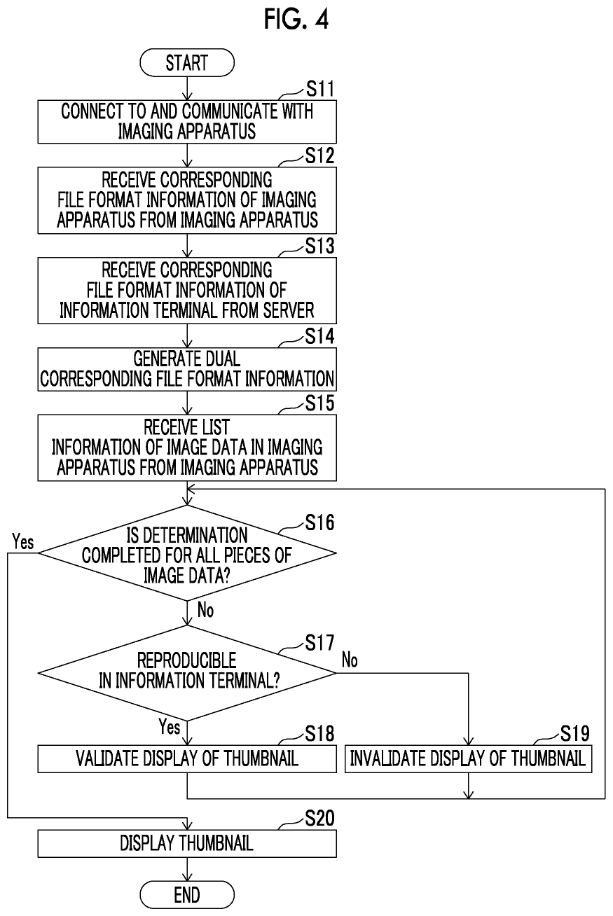

FIG. 4 is a flowchart showing an example of processing performed by the processor 21 of the information terminal 20. For example, the information terminal 20 starts the present processing in a case where the image transmission application for causing the information terminal 20 to receive the image data captured by the imaging apparatus 10 starts.

First, the information terminal 20 communicates with the imaging apparatus 10 via, for example, wireless communication (step S11).

Next, the information terminal 20 receives corresponding file format information indicating an image file format supported by the imaging apparatus 10 from the connected imaging apparatus 10 (step S12). The image file format includes at least any of an image size (4K, 8K, or the like), a frame rate, or a compression codec. The image file format is a combination of a plurality of types of file formats. The plurality of types of file formats include an image size, a file format, a bit rate, a frame rate, a compression codec, and the like. The corresponding file format information is information indicating all file formats that are capturable by the imaging apparatus 10, and is information indicating a file format that is storable in the memory 12 in the imaging apparatus by imaging via the imaging apparatus 10. The corresponding file format information of the imaging apparatus 10 is an example of “first file format information” according to the embodiment of the present invention.

Next, the information terminal 20 connects to and communicates with the server 30 through the network 2, and receives the corresponding file format information indicating the image file format supported by the current information terminal 20 from the server 30 based on the file format information supported by the imaging apparatus 10, which is received in step S12 (step S13). A file format supported by the information terminal 20 means, for example, a file format that is reproducible in the information terminal 20, or a file format that is storable in the information terminal 20. The information terminal 20 receives the file format supported by the information terminal 20 among file formats supported by the imaging apparatus 10 from the server 30. The corresponding file format information of the information terminal 20 is an example of “third file format information” according to the embodiment of the present invention.

While the present example describes a case where the corresponding file format information of the information terminal 20 is stored in the server 30, the present invention is not limited to this. For example, the corresponding file format information of the information terminal 20 may be stored in the imaging apparatus 10. The information terminal 20 may receive the corresponding file format information of the information terminal 20 from the imaging apparatus 10. The imaging apparatus 10 is an example of the “data storage apparatus” according to the embodiment of the present invention.

Next, the information terminal 20 generates dual corresponding file format information for specifying a file format that is capturable by the imaging apparatus 10 and is reproducible in the information terminal 20, based on the corresponding file format information of the imaging apparatus 10 received in step S12 and on the corresponding file format information of the information terminal 20 received in step S13 (step S14). The dual corresponding file format information is an example of “second file format information” according to the embodiment of the present invention.

Next, the information terminal 20 receives list information of the image data stored in the imaging apparatus 10 from the imaging apparatus 10 (step S15). The list information is a list of file formats of the image data that is captured by the imaging apparatus 10 and is stored in the memory 12 of the imaging apparatus 10.

Next, the information terminal 20 determines whether or not a determination is completed for all pieces of the image data in the list information received in step S16 (step S16). This determination is a determination as to whether or not the file format of the received image data is a file format that is reproducible in the information terminal 20.

In step S16, in a case where the determination is not completed for all pieces of the image data (step S16: No), the information terminal 20 determines whether or not a file format of undetermined image data is a file format that is reproducible in the information terminal 20 (step S17).

In step S17, in a case where the file format is reproducible in the information terminal 20 (step S17: Yes), the information terminal 20 validates display of a thumbnail of the determined image data (step S18), and then returns to step S16 to repeat each processing. In step S17, in a case where the file format is not reproducible in the information terminal 20 (step S17: No), the information terminal 20 invalidates display of the thumbnail of the determined image data (step S19), and then returns to step S16 to repeat each processing.

On the other hand, in step S16, in a case where the determination is completed for all pieces of the image data (step S16: Yes), the information terminal 20 proceeds to step S20 and displays a thumbnail related to the image data on the user interface 24 (display) of the information terminal 20 (step S20). A display location for displaying the thumbnail related to the image data is not limited to the display of the information terminal 20, and may be, for example, a display device separated from the information terminal 20.

Display of a thumbnail may be display of only a thumbnail related to valid image data, or display of all thumbnails such that validity/invalidity related to all pieces of the image data can be understood. For example, a thumbnail with a “validity mark” or a thumbnail having a changed color may be used for image data that is reproducible in the information terminal 20. In addition, for example, thumbnails of all pieces of the image data may be displayed, and in a case where an instruction to download unreproducible image data is issued, reception of the image data from the imaging apparatus 10 to the information terminal 20 may be restricted, a warning may be output, or restriction and output of the warning may be performed. Restriction of the reception is, for example, blocking reception so that reception cannot be performed. Output of the warning is output of warning information indicating that an image is not reproducible (storable).

For example, in a case where the user selects a file format displayed as a valid thumbnail on the display of the information terminal 20 on which display of the thumbnail is performed, the image data in the selected file format is transmitted from the imaging apparatus 10 to the information terminal 20.

As described above, according to the information terminal 20 of the embodiment, the dual corresponding file format information indicating an image file format that is capturable by the imaging apparatus 10 and is reproducible or storable in the information terminal 20 can be generated by acquiring, from the connected and communicating imaging apparatus 10, the file format information indicating an image file format that is capturable by the imaging apparatus 10, and acquiring, from the server 30, the file format information indicating an image file format that is reproducible or storable in the current information terminal 20. For example, a thumbnail of information on the image data that is reproducible or storable in the information terminal 20 among pieces of the image data stored in the memory of the currently connected and communicating imaging apparatus 10 can be displayed based on the dual corresponding file format information. Thus, an event in which the user selects image data that is not reproducible or storable in the information terminal 20 in transmitting the image data captured by the imaging apparatus 10 to the information terminal 20 can be prevented. Accordingly, occurrence of unnecessary time and unnecessary communication charges in starting the image transmission application can be reduced, and usability can be improved.

### First Modification Example of Processing of Information Terminal 20

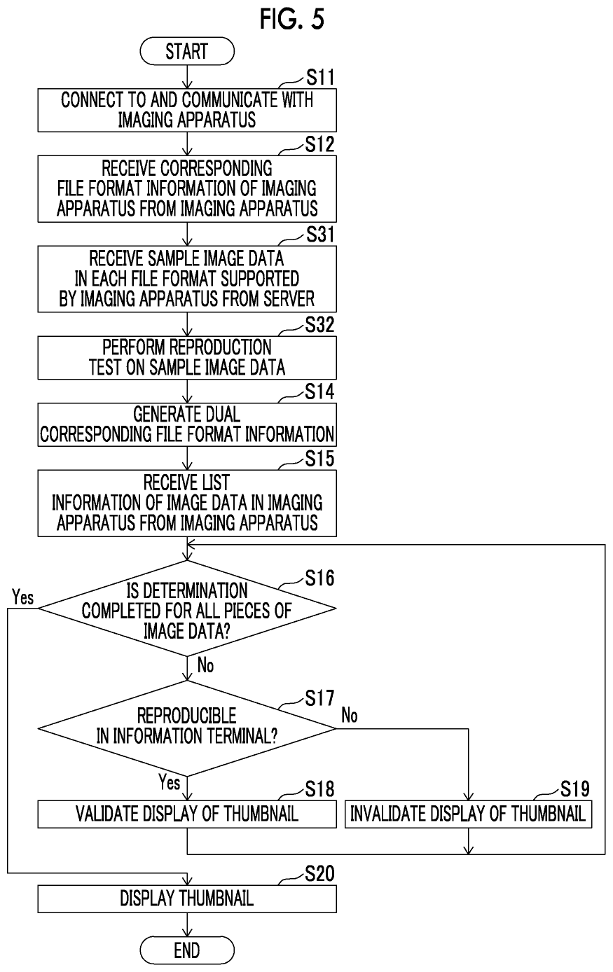

FIG. 5 is a flowchart showing a first modification example of the processing performed by the processor 21 of the information terminal 20. As shown in FIG. 5, processing of step S11 and step S12 is the same as processing of step S11 and step S12 described in FIG. 4.

Next, the information terminal 20 receives, from the server 30, sample image data in each file format supported by the imaging apparatus 10 in the corresponding file format information of the imaging apparatus 10 received in step S12 (step S31). The sample image data is small-size image data for testing in an image file format supported by the imaging apparatus 10. The sample image data is an example of “test image data” according to the embodiment of the present invention.

While the present example describes a case where the sample image data is stored in the server 30 and is received from the server 30, the present invention is not limited to this. For example, the sample image data may be stored in the imaging apparatus 10. The information terminal 20 may receive the sample image data from the imaging apparatus 10.

Next, the information terminal 20 performs a reproduction test on the sample image data received from the server 30 in step S31 (step S32). The reproduction test is a determination as to whether or not the sample image data is reproducible in the information terminal 20.

Next, the information terminal 20 generates the dual corresponding file format information that is capturable by the imaging apparatus 10 and is reproducible in the information terminal 20, based on a result of the reproduction test of the sample image data in step S32 (step S14).

Processing from step S15 to step S20 is the same as each processing from step S15 to step S20 described in FIG. 4.

According to the information terminal 20 of the first modification example, a reproduction operation is actually performed using the sample image data for testing in order to determine whether or not the file format is reproducible in the information terminal 20. Thus, further accurate dual corresponding file format information can be generated. In addition, for example, occurrence of an operation mistake can be reduced, compared to a case where the reproduction operation is performed by the user. In addition, maintenance labor of a provider of the image transmission application can be reduced.

### Second Modification Example of Processing of Information Terminal 20

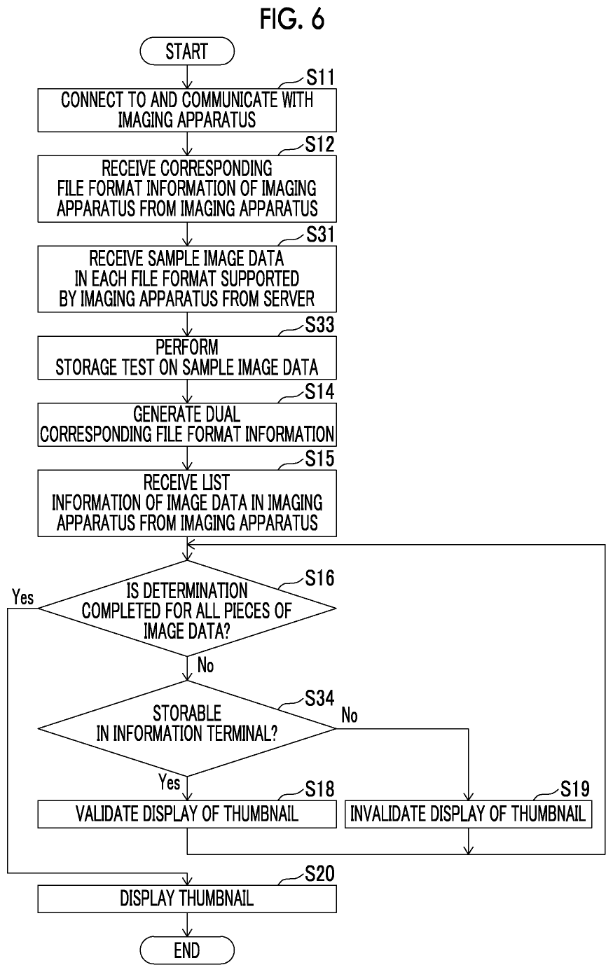

FIG. 6 is a flowchart showing a second modification example of the processing performed by the processor 21 of the information terminal 20. Processing in the second modification example is different from processing of performing the reproduction test on the sample image data in the first modification example described in FIG. 5, in that a storage test is performed on the sample image data. As shown in FIG. 6, processing of step S11, step S12, and step S31 is the same as processing of step S11, step S12, and step S31 described in FIG. 5.

Next, the information terminal 20 performs a storage test on the sample image data received from the server 30 in step S31 (step S33). The storage test is a determination as to whether or not the sample image data is storable in the information terminal 20.

Next, the information terminal 20 generates the dual corresponding file format information that is capturable by the imaging apparatus 10 and is storable in the information terminal 20, based on a result of the storage test of the sample image data in step S33 (step S14).

Processing of step S15 and step S16 is the same as processing of step S15 and step S16 described in FIG. 5.

Next, in step S16, in a case where the determination is not completed for all pieces of the image data (step S16: No), the information terminal 20 determines whether or not the currently determined image data is storable in the information terminal 20 (step S34).

Processing from step S18 to step S20 is the same as each processing from step S18 to step S20 described in FIG. 5.

According to the information terminal 20 of the second modification example, a storage operation is actually performed using the sample image data for testing in order to determine whether or not the file format is storable in the information terminal 20. Thus, further accurate dual corresponding file format information can be generated. In addition, for example, occurrence of an operation mistake can be reduced, compared to a case where the storage operation is performed by the user. In addition, maintenance labor of a provider of the image transmission application can be reduced.

### Third Modification Example of Processing of Information Terminal 20

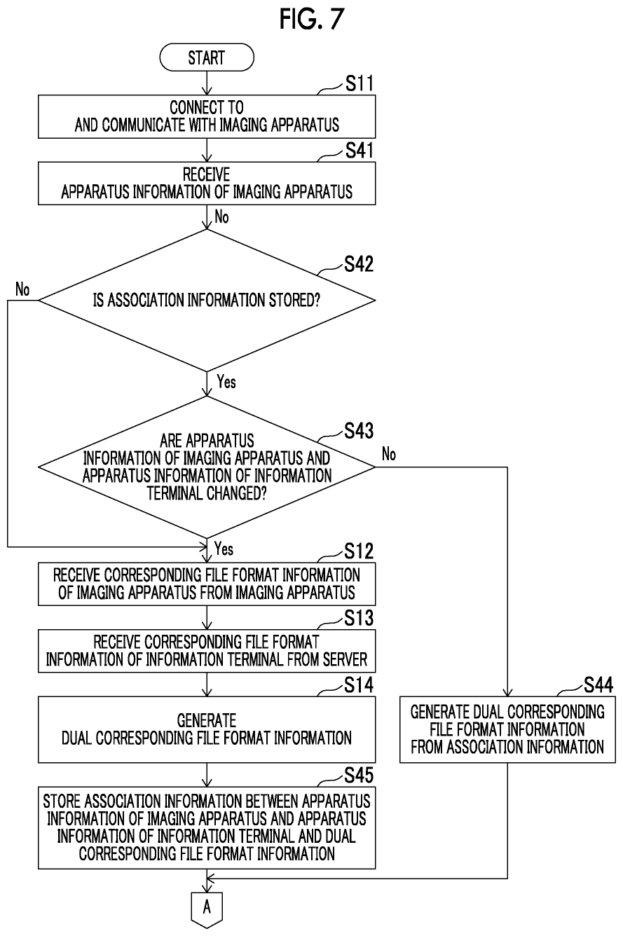

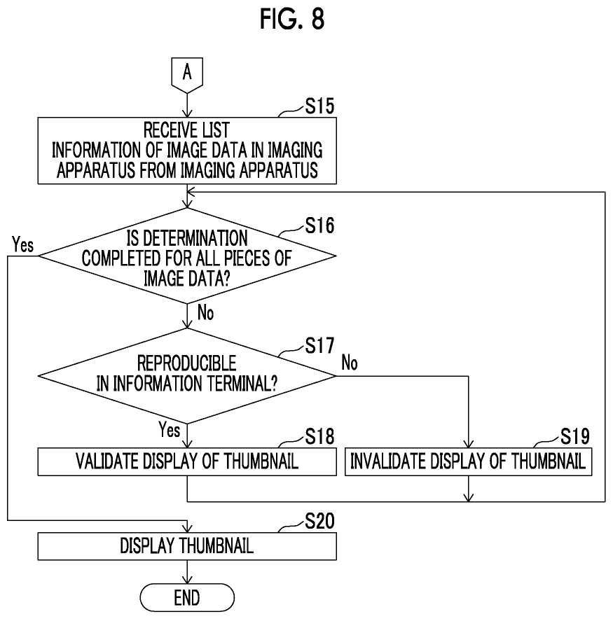

FIGS. 7 and 8 are flowcharts showing a third modification example of the processing performed by the processor 21 of the information terminal 20. Processing in the third modification example is processing of using information again in a case where there is no change in contents of the dual corresponding file format information generated in the past.

First, the information terminal 20, as in the processing in FIG. 4, connects to and communicates with the imaging apparatus 10 (step S11).

Next, the information terminal 20 receives apparatus information of the imaging apparatus 10 from the connected imaging apparatus 10 (step S41). The apparatus information of the imaging apparatus 10 is a software version of the connected imaging apparatus 10, a model name of the imaging apparatus 10, and the like.

Next, the information terminal 20 determines whether or not association information between the imaging apparatus 10 and the information terminal 20 is stored in the information terminal 20 (step S42). The association information is information in which the dual corresponding file format information indicating an image file format that is capturable by the imaging apparatus 10 and is reproducible in the information terminal 20 is associated with each combination of the apparatus information of the imaging apparatus 10 and apparatus information of the information terminal 20. The apparatus information of the information terminal 20 is an operating system (OS) version of the information terminal 20, a model name of the information terminal 20, and the like.

In step S42, in a case where the association information between the imaging apparatus 10 and the information terminal 20 is stored (step S42: Yes), the information terminal 20 determines whether or not the apparatus information of the imaging apparatus 10 and the apparatus information of the information terminal 20 are changed (step S43).

In step S43, in a case where the apparatus information of the imaging apparatus 10 and the apparatus information of the information terminal 20 are not changed (step S43: No), the information terminal 20 generates the dual corresponding file format information from the stored association information (step S44), and then proceeds to step S15 in FIG. 8. That is, in a case where the apparatus information of the imaging apparatus 10 and the apparatus information of the information terminal 20 included in the stored association information coincide with the apparatus information of the current imaging apparatus 10 and the apparatus information of the current information terminal 20, the dual corresponding file format information included in the stored association information is used.

In step S43, in a case where the apparatus information of the imaging apparatus 10 and the apparatus information of the information terminal 20 are changed (step S43: Yes), the information terminal 20 receives the corresponding file format information of the imaging apparatus 10 from the connected imaging apparatus 10 (step S12), receives the corresponding file format information of the information terminal 20 from the server 30 (step S13), and then generates the dual corresponding file format information (step S14). Processing from step S12 to step S14 is the same as each processing from step S12 to step S14 in FIG. 4.

Next, the information terminal 20 stores, in the memory 22 of the information terminal 20, the association information in which the apparatus information of the imaging apparatus 10 and the apparatus information of the information terminal 20 are associated with the dual corresponding file format information (step S45). After storing the association information, the information terminal 20 proceeds to step S15 in FIG. 8.

Processing from step S15 to step S20 is the same as each processing from step S15 to step S20 described in FIG. 4. Instead of processing of receiving the corresponding file format information of the information terminal 20 from the server 30 in step S13, a test format of the sample image data may be received as described in FIGS. 5 and 6.

According to the information terminal 20 of the third modification example, in a case where states of the imaging apparatus 10 and the information terminal 20 are not changed from those at the start of the image transmission application in the past, the dual corresponding file format information used in the past can be used. Thus, predetermined processing at the start of the image transmission application can be omitted, and a time required before use of the image transmission application starts can be reduced.

### Fourth Modification Example of Processing of Information Terminal 20

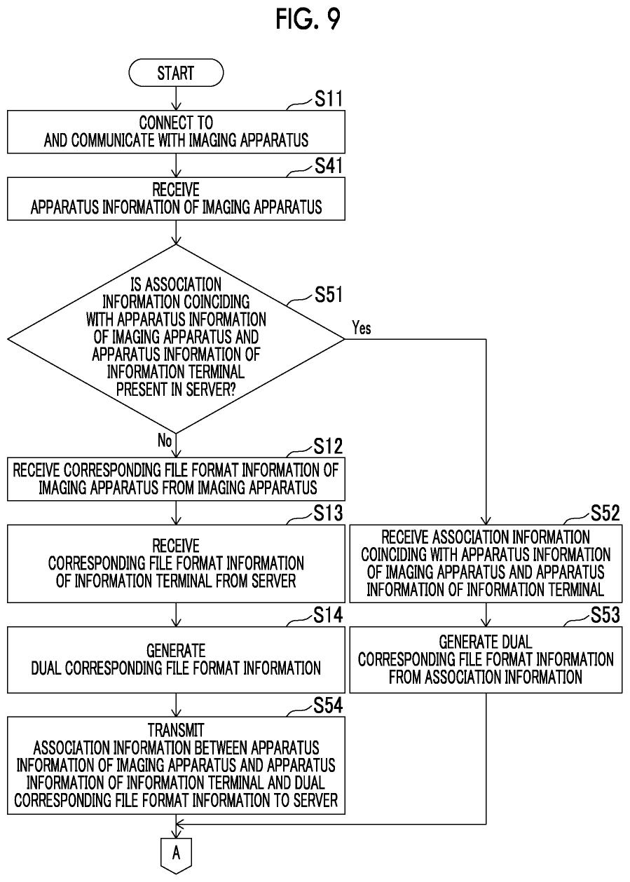

FIG. 9 is a flowchart showing a fourth modification example of the processing performed by the processor 21 of the information terminal 20. Processing in the fourth modification example is different from the processing in the third modification example in FIG. 7 in which the information terminal 20 stores the association information, in that the server 30 stores the association information between the imaging apparatus 10 and the information terminal 20.

The information terminal 20, as in the processing in FIG. 7, connects to and communicates with the imaging apparatus 10 (step S11), and then receives the apparatus information of the imaging apparatus 10 from the connected imaging apparatus 10 (step S41).

Next, the information terminal 20 determines whether or not the association information coinciding with the apparatus information of the imaging apparatus 10 and the apparatus information of the information terminal 20 is stored in the server 30 (step S51). The information terminal 20 communicates with the server 30 to check whether the coinciding association information is stored, and determines whether the association information is stored based on a response from the server 30. As described in the third modification example, the association information is information in which the dual corresponding file format information indicating an image file format that is capturable by the imaging apparatus 10 and is reproducible in the information terminal 20 is associated with each combination of the apparatus information of the imaging apparatus 10 and the apparatus information of the information terminal 20. As long as the combination of the apparatus information of the imaging apparatus 10 and the apparatus information of the information terminal 20 in the association information is the same, the user does not need to be the same.

In step S51, in a case where the association information is stored in the server 30 (step S51: Yes), the information terminal 20 receives the association information coinciding with the apparatus information of the imaging apparatus 10 and the apparatus information of the information terminal 20 from the server 30 (step S52).

Next, the information terminal 20 generates the dual corresponding file format information from the association information received in step S52 (step S53), and then proceeds to step S15 in FIG. 8. That is, in a case where there is information coinciding with the apparatus information of the current imaging apparatus 10 and the apparatus information of the current information terminal 20 in the association information stored in the server 30, the dual corresponding file format information included in the association information is used.

Processing from step S12 to step S14 after step S51 in which the association information is not stored in the server 30 (step S51: No) is the same as processing from step S12 to step S14 in the third modification example in FIG. 7.

Next, the information terminal 20 transmits, to the server 30, the association information in which the apparatus information of the imaging apparatus 10 and the apparatus information of the information terminal 20 are associated with the dual corresponding file format information (step S54). After transmitting the association information to the server 30, the information terminal 20 proceeds to step S15 in FIG. 8.

According to the information terminal 20 of the fourth modification example, as in the third modification example, the dual corresponding file format information used in the past can be used, and a time required before use of the image transmission application starts can be reduced.

### Fifth Modification Example of Processing of Information Terminal 20

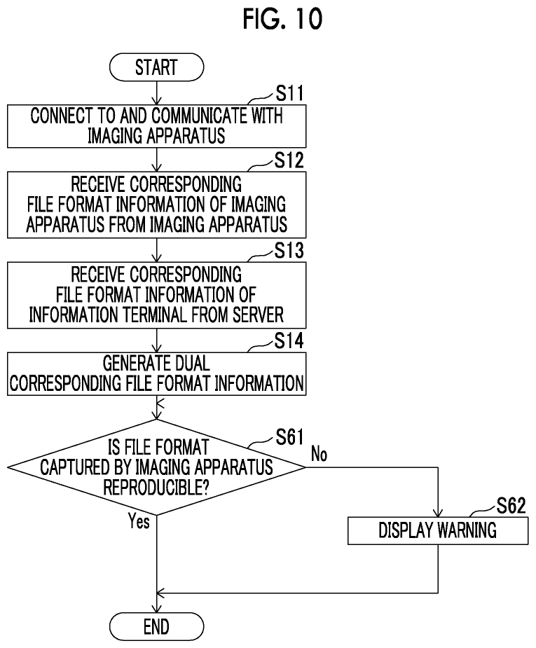

FIG. 10 is a flowchart showing a fifth modification example of the processing performed by the processor 21 of the information terminal 20. As shown in FIG. 10, processing from step S11 to step S14 is the same as each processing from step S11 to step S14 described in FIG. 4. However, while not described in FIG. 4, the corresponding file format information of the imaging apparatus 10 received in step S12 includes current setting information indicating a file format set in the current imaging apparatus 10.

Next, the information terminal 20 determines whether or not the image file format captured by the connected and communicating imaging apparatus 10 is reproducible in the information terminal 20 (step S61). The file format captured by the imaging apparatus 10 is an image file format currently set in the imaging apparatus 10, and is a file format used for storing captured image data in a case where imaging is currently performed. A file format that is reproducible in the information terminal 20 means a file format included in file formats that are reproducible in the information terminal 20.

In step S61, in a case where the image file format currently set in the imaging apparatus 10 is not reproducible in the information terminal 20 (step S61: No), the information terminal 20 displays a warning for notifying the user that reproduction cannot be performed (step S62). Display of a warning may be displayed on the user interface 14 (display) of the imaging apparatus 10, or display on the user interface 24 (display) of the information terminal 20.

While whether or not a file format is reproducible in the information terminal 20 is determined in the present example, the present invention is not limited to this. For example, whether or not a file format is storable may be determined. In addition, for example, in a case where a file format is not reproducible (storable) in the information terminal 20, the information terminal 20 may perform a control of changing the image file format set in the imaging apparatus 10 to an image file format that is reproducible (storable) in the information terminal 20. In addition, the information terminal 20 may combine the control of changing the image file format with user notification via a warning. In addition, instead of processing of receiving the corresponding file format information of the information terminal 20 from the server 30 in step S13, a test format of the sample image data may be received as described in FIGS. 5 and 6.

According to the information terminal 20 of the fifth modification example, even in a case where an image is captured in a setting state of the imaging apparatus 10, the user can be notified that the captured image is not reproducible (storable) in the current information terminal 20. Thus, transmission of unnecessary image data from the imaging apparatus 10 to the information terminal 20 can be prevented in advance. In addition, transmission of unnecessary image data from the imaging apparatus 10 to the information terminal 20 can also be prevented in advance by changing the setting state of the imaging apparatus 10 to a file format that is reproducible (storable) in the information terminal 20.

### Example of Displaying Warning

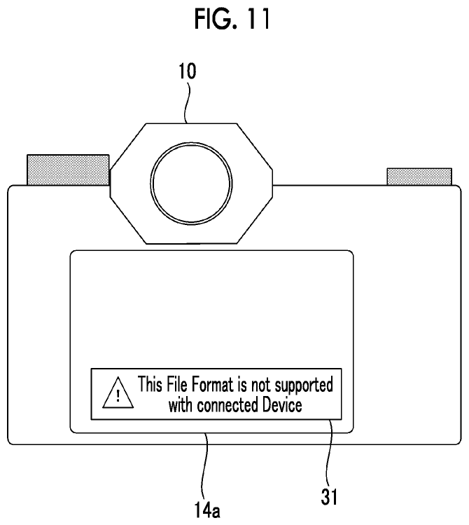

FIG. 11 is a diagram showing an example of a warning message displayed on the imaging apparatus 10. As shown in FIG. 11, for example, a warning message 31 for notifying that “an image captured in a file format set in the imaging apparatus 10 is not reproducible (storable) in the connected information terminal 20” is displayed on a display 14a provided on a rear surface of the imaging apparatus 10.

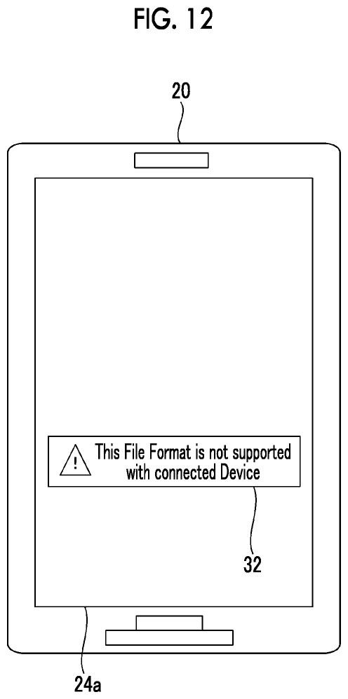

FIG. 12 is a diagram showing an example of a warning message displayed on the information terminal 20. As shown in FIG. 12, for example, a warning message 32 for notifying that “an image captured in a file format set in the connected imaging apparatus 10 is not reproducible (storable) in the current information terminal 20” is displayed on a display 24a provided in the information terminal 20.

### Sixth Modification Example of Processing of Information Terminal 20

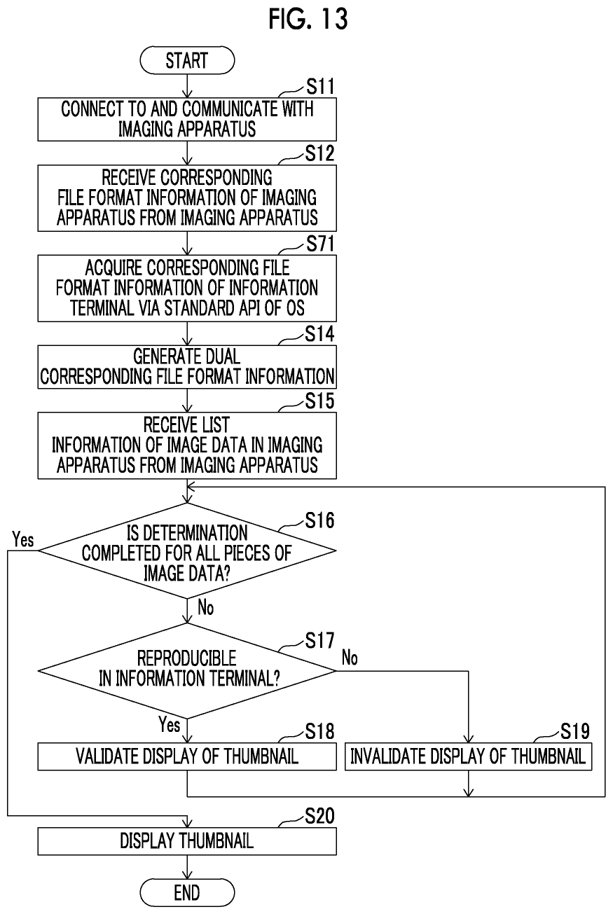

FIG. 13 is a flowchart showing a sixth modification example of the processing performed by the processor 21 of the information terminal 20. As shown in FIG. 13, the information terminal 20 connects to and communicates with the imaging apparatus 10 (step S11), and then receives the corresponding file format information indicating an image file format supported by the imaging apparatus 10 from the connected imaging apparatus 10 (step S12).

Next, the information terminal 20 acquires the corresponding file format information of the information terminal 20 via a standard application programming interface (API) of the OS (step S71). That is, in a case where the information terminal 20 can recognize the corresponding file format information of the current information terminal 20 via the OS of the current information terminal 20, the information terminal 20 acquires the corresponding file format information via the API. The corresponding file format information of the information terminal 20 may be stored in the information terminal 20. The information terminal 20 may be an example of the “data storage apparatus” according to the embodiment of the present invention.

Processing from step S14 to step S20 is the same as each processing from step S14 to step S20 described in FIG. 4.

According to the information terminal 20 of the sixth modification example, maintenance labor of a provider of the image transmission application can be reduced.

### Seventh Modification Example of Processing of Information Terminal 20

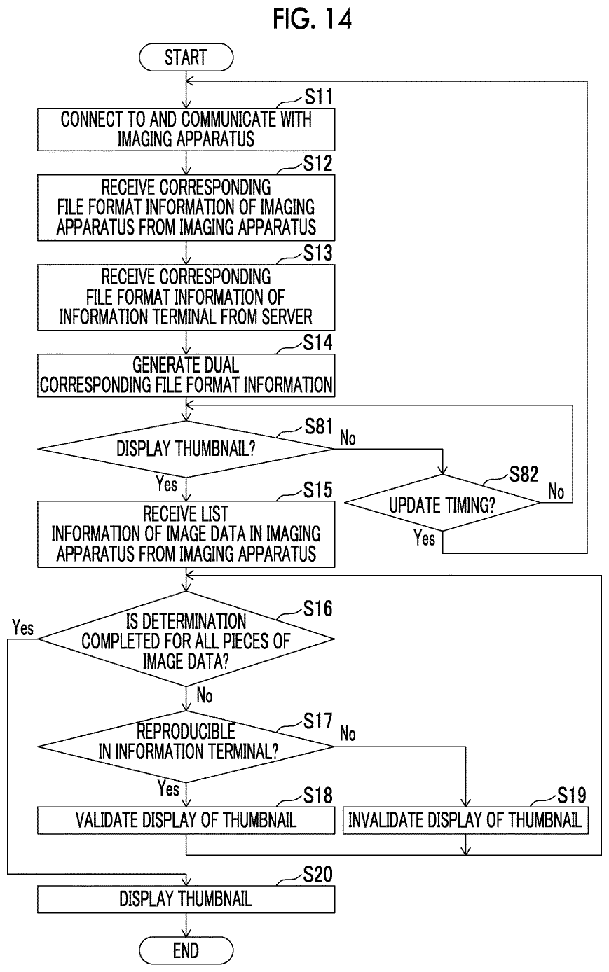

FIG. 14 is a flowchart showing a seventh modification example of the processing performed by the processor 21 of the information terminal 20. As shown in FIG. 14, processing from step S11 to step S14 is the same as each processing from step S11 to step S14 described in FIG. 4.

Next, the information terminal 20 determines whether or not to display a thumbnail (step S81). Whether or not to display a thumbnail is determined by, for example, determining whether or not an instruction to display a thumbnail is received from the user, or whether or not a current mode is a mode in which a thumbnail is displayed.

In step S81, in a case where a thumbnail is not displayed (step S81: No), the information terminal 20 determines whether or not an update timing of the dual corresponding file format information is reached (step S82).

In step S82, in a case where the update timing of the dual corresponding file format information is not reached (step S82: No), the information terminal 20 returns to step S81 and repeats each processing. In step S82, in a case where the update timing of the dual corresponding file format information is reached (step S82: Yes), the information terminal 20 returns to step S11 and repeats each processing. The update timing of the dual corresponding file format information is, for example, a time when idling or file transmission of the image transmission application occurs.

Processing from step S15 to step S20 after step S81 in which a thumbnail is displayed (step S81: Yes) is the same as each processing from step S15 to step S20 in FIG. 4. Instead of processing of receiving the corresponding file format information of the information terminal 20 from the server 30 in step S13, a test format of the sample image data may be received as described in FIGS. 5 and 6.

According to the information terminal 20 of the seventh modification example, even in a case where the dual corresponding file format information changes in starting the image transmission application, the latest dual corresponding file format information can be acquired for each update timing. Thus, an event in which the user selects image data that is not reproducible or storable in the information terminal 20 can be further prevented. Accordingly, occurrence of unnecessary time and unnecessary communication charges in starting the image transmission application can be reduced, and usability can be improved.

### Eighth Modification Example of Processing of Information Terminal 20

In the processing of the information terminal 20 described above, the corresponding file format information that is capturable by the imaging apparatus 10 is acquired from the connected and communicating imaging apparatus 10, and the dual corresponding file format information that is capturable by the imaging apparatus 10 and is reproducible/storable in the information terminal 20 (current information terminal 20) is generated based on the acquired corresponding file format information. However, the present invention is not limited to this. The information terminal 20 may generate, for example, the dual corresponding file format information that is capturable by the imaging apparatus 10 and is reproducible/storable in another information terminal 20 other than the current information terminal 20, based on the corresponding file format information acquired from the imaging apparatus 10. The other information terminal 20 other than the current information terminal 20 is an example of a “second information processing apparatus” according to the embodiment of the present invention.

### Ninth Modification Example of Processing of Information Terminal 20

While a configuration in which the information terminal 20 generates the dual corresponding file format information (second file format information) and receives the image data from the imaging apparatus 10 based on the dual corresponding file format information is described, the present invention is not limited to such a configuration. That is, generation of the dual corresponding file format information and reception of the image data from the imaging apparatus 10 based on the dual corresponding file format information may be performed by separate information terminals.

The information processing method described in the above embodiment can be implemented by executing an information processing program prepared in advance via a computer. The information processing program is recorded on a computer-readable storage medium and is executed by reading out the information processing program from the storage medium. The information processing program may be provided in a form thereof stored in a non-transitory storage medium such as a flash memory, or may be provided through a network such as the Internet. The computer that executes the information processing program may be included in the information processing apparatus, may be included in an electronic apparatus such as a smartphone, a tablet terminal, or a personal computer capable of communicating with the information processing apparatus, or may be included in a server apparatus capable of communicating with the information processing apparatus and the electronic apparatus.

While various embodiments are described above, the present invention is not limited to such examples. Those skilled in the art may apparently perceive various modification examples or correction examples within the scope according to the claims, and those examples are also construed as falling within the technical scope of the present invention. Each constituent in the above embodiment may be adopted in any combination without departing from the gist of the invention.

The present application is based on Japanese Patent Application (JP2023-158620) filed on Sep. 22, 2023, the content of which is incorporated in the present application by reference.

### EXPLANATION OF REFERENCES

1: communication system
2: network
10: imaging apparatus
11, 21: processor
12, 22: memory
13, 23: communication interface
14, 24: user interface
14a, 24a: display
15: imaging module
19, 29: bus
20: information terminal
30: server
31, 32: warning message

What is claimed is:

1. An information processing apparatus comprising:
a processor,
wherein the processor is configured to:
perform processing of connecting to and communicating with an imaging apparatus;
acquire first file format information indicating an image file format supported by the imaging apparatus, and based on the first file format information, generate second file format information indicating an image file format that is supported by the imaging apparatus and is supported by the information processing apparatus; and
perform a control based on the second file format information;
wherein the control based on the second file format information is a control related to reception of image data stored in the imaging apparatus, and
the control based on the second file format information includes a control of restricting reception, from the imaging apparatus, of the image data corresponding to an image file format which is determined not to be supported by the information processing apparatus based on the second file format information.

2. The information processing apparatus according to claim 1,
wherein the control based on the second file format information includes a control of receiving, from the imaging apparatus, information on image data that is stored in the imaging apparatus and corresponds to an image file format which is determined to be supported by the information processing apparatus based on the second file format information, and outputting the information to a display location.

3. The information processing apparatus according to claim 1,
wherein the control based on the second file format information includes user notification based on a file format set in the imaging apparatus and on the second file format information.

4. The information processing apparatus according to claim 3,
wherein the user notification includes notification via the imaging apparatus or the information processing apparatus.

5. The information processing apparatus according to claim 1,
wherein the control based on the second file format information includes setting a file format in the imaging apparatus based on the second file format information.

6. An information processing apparatus, comprising
a processor,
wherein the processor is configured to:
perform processing of connecting to and communicating with an imaging apparatus;
acquire first file format information indicating an image file format supported by the imaging apparatus, and based on the first file format information, generate second file format information indicating an image file format that is supported by the imaging apparatus and is supported by the information processing apparatus;
perform a control based on the second file format information;
acquire, from a data storage apparatus, third file format information indicating the image file format that is supported in the information processing apparatus; and
generate the second file format information based on the first file format information and on the third file format information.

7. An information processing apparatus, comprising
a processor,
wherein the processor is configured to:
perform processing of connecting to and communicating with an imaging apparatus;
acquire first file format information indicating an image file format supported by the imaging apparatus, and based on the first file format information, generate second file format information indicating an image file format that is supported by the imaging apparatus and is supported by the information processing apparatus; and
perform a control based on the second file format information; and
acquire test image data in an image file format supported by the imaging apparatus from a data storage apparatus or the imaging apparatus; and
generate the second file format information based on the test image data.

8. The information processing apparatus according to claim 7,
wherein the processor is configured to generate the second file format information based on a result of performing at least any of reproduction or storage of the test image data.

9. The information processing apparatus according to claim 6,
wherein the data storage apparatus is an apparatus different from the information processing apparatus.

10. An information processing apparatus, comprising
a processor,
wherein the processor is configured to:
perform processing of connecting to and communicating with an imaging apparatus;
acquire first file format information indicating an image file format supported by the imaging apparatus, and based on the first file format information, generate second file format information indicating an image file format that is supported by the imaging apparatus and is supported by the information processing apparatus;
perform a control based on the second file format information;
acquire association information in which apparatus information is associated with the second file format information; and
in a case where the apparatus information included in the association information coincides with apparatus information of the imaging apparatus and apparatus information of the information processing apparatus, perform the control based on the second file format information included in the association information.

11. The information processing apparatus according to claim 10,
wherein the processor is configured to:
in a case where the second file format information is generated, store association information in which the apparatus information of the imaging apparatus and the apparatus information of the information processing apparatus are associated with the second file format information, in a memory of the information processing apparatus; and
acquire the association information from the memory.

12. The information processing apparatus according to claim 10,
wherein the processor is configured to acquire the association information from an apparatus different from the information processing apparatus.

13. The information processing apparatus according to claim 1,
wherein the image file format includes at least any of an image size, a frame rate, or a compression codec.

14. The information processing apparatus according to claim 1,
wherein the image file format is a combination of a plurality of types of file formats.

15. An information processing method performed by an information processing apparatus including a processor, the method comprising:
via the processor,
performing processing of connecting to and communicating with an imaging apparatus;
acquiring first file format information indicating an image file format supported by the imaging apparatus, and based on the first file format information, generating second file format information indicating an image file format that is supported by the imaging apparatus and is supported by the information processing apparatus; and
performing a control based on the second file format information,
wherein the control based on the second file format information is a control related to reception of image data stored in the imaging apparatus, and
the control based on the second file format information includes a control of restricting reception, from the imaging apparatus, of the image data corresponding to an image file format which is determined not to be supported by the information processing apparatus based on the second file format information.

16. A non-transitory computer-readable storage medium storing an information processing program of an information processing apparatus including a processor, the program causing the processor to execute a process comprising:
performing processing of connecting to and communicating with an imaging apparatus;
acquiring first file format information indicating an image file format supported by the imaging apparatus, and based on the first file format information, generating second file format information indicating an image file format that is supported by the imaging apparatus and is supported by the information processing apparatus; and
performing a control based on the second file format information that is a control related to reception of image data stored in the imaging apparatus, the control based on the second file format information including a control of restricting reception, from the imaging apparatus, of the image data corresponding to an image file format which is determined not to be supported by the information processing apparatus based on the second file format information.
